(19) United States
(12) Patent Application Publication
(10) Pub. No.: US 2025/0211798 A1
(43) Pub. Date: Jun. 26, 2025

(54) INTRA PREDICTION WITH IN-LOOP FILTERS

(71) Applicant: Tencent America LLC, Palo Alto, CA (US)

(72) Inventors: Biao WANG, San Jose, CA (US); Roman CHERNYAK, Santa Clara, CA (US); Lien-Fei CHEN, Palo Alto, CA (US); Yonguk YOON, Palo Alto, CA (US); Motong XU, Palo Alto, CA (US); Shan LIU, San Jose, CA (US)

(73) Assignee: Tencent America LLC, Palo Alto, CA (US)

(21) Appl. No.: 18/986,509

(22) Filed: Dec. 18, 2024

Related U.S. Application Data
(60) Provisional application No. 63/612,705, filed on Dec. 20, 2023.

(51) Int. Cl. H04N 19/82; H04N 19/105; H04N 19/159; H04N 19/176; H04N 19/55

(52) U.S. Cl. CPC H04N 19/82; H04N 19/105; H04N 19/159; H04N 19/176; H04N 19/55

(57) ABSTRACT

Some aspects of the disclosure provide a method of video decoding. In the method, a coded video bitstream comprising coded information of a current block in a current picture is received. The coded information of the current block indicates an intra prediction mode for the current block. One or more in-loop filters is applied on one or more reconstructed samples in the current picture to generate one or more filtered reconstructed samples. The current block is reconstructed using the intra prediction mode and based on the one or more filtered reconstructed samples.

### INCORPORATION BY REFERENCE

The present application claims the benefit of priority to U.S. Provisional Application No. 63/612,705, “IMPROVING INTRA PREDICTION WITH IN-LOOP FILTERS” filed on Dec. 20, 2023, which is incorporated by reference herein in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of video decoding. In the method, a coded video bitstream comprising coded information of a current block in a current picture is received. The coded information of the current block indicates an intra prediction mode for the current block. One or more in-loop filters is applied on one or more reconstructed samples in the current picture to generate one or more filtered reconstructed samples. The current block is reconstructed using the intra prediction mode and based on the one or more filtered reconstructed samples.

Some aspects of the disclosure provide a method of video encoding. In the method, use of an intra prediction mode for coding a current block in a current picture is determined. One or more in-loop filters is applied on one or more reconstructed samples in the current picture to generate one or more filtered reconstructed samples. The current block is encoded into coded information in a coded video bitstream using the intra prediction mode and based on the one or more filtered reconstructed samples.

Some aspects of the disclosure provide a method of processing visual media data. The method includes processing a bitstream of visual media data according to a format rule. The bitstream includes coded information of a current block in a current picture. The coded information of the current block indicates an intra prediction mode for the current block. The format rule specifies that one or more in-loop filters are applied on one or more reconstructed samples in the current picture to generate one or more filtered reconstructed samples. The format rule specifies that the current block is reconstructed using the intra prediction mode and based on the one or more filtered reconstructed samples.

Aspects of the disclosure also provide an apparatus for video encoding. The apparatus for video encoding including processing circuitry configured to implement any of the described methods for video encoding.

Aspects of the disclosure also provide a method for video decoding. The method including any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows a diagram of angular intra prediction in some examples.

FIG. 5 shows diagrams for applications of deblocking filters in some examples.

FIG. 6 shows a diagram of a picture using a template-based approach to determine a block vector for intra prediction in some examples.

FIG. 7 shows a diagram of a block vector based intra prediction in some examples.

FIG. 8 shows a diagram for a template based intra mode derivation in some examples.

FIG. 9 shows a flow chart outlining a decoding process according to some aspects of the disclosure.

FIG. 10 shows a flow chart outlining an encoding process according to some aspects of the disclosure.

FIG. 11 is a schematic illustration of a computer system in accordance with an aspect.

### DETAILED DESCRIPTION

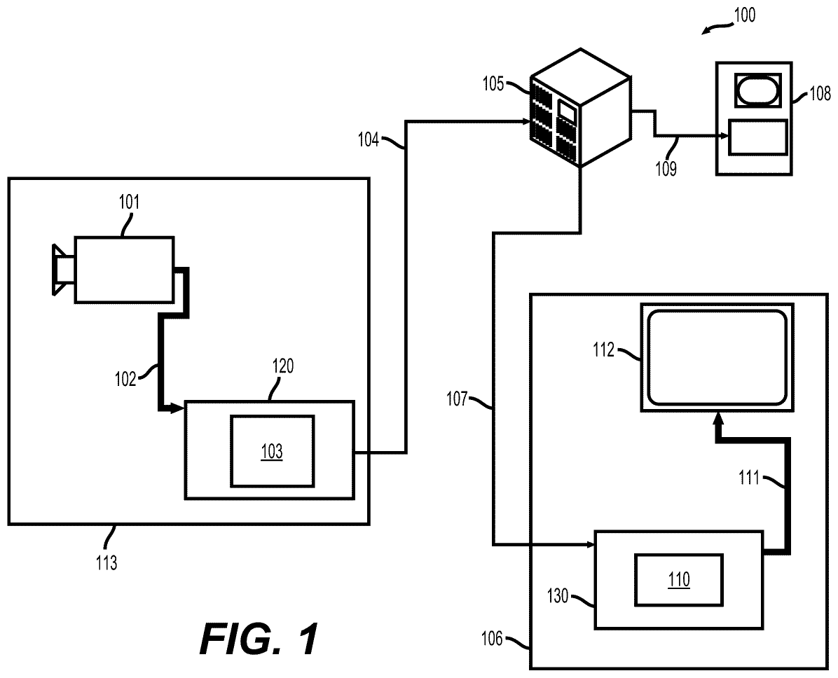

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

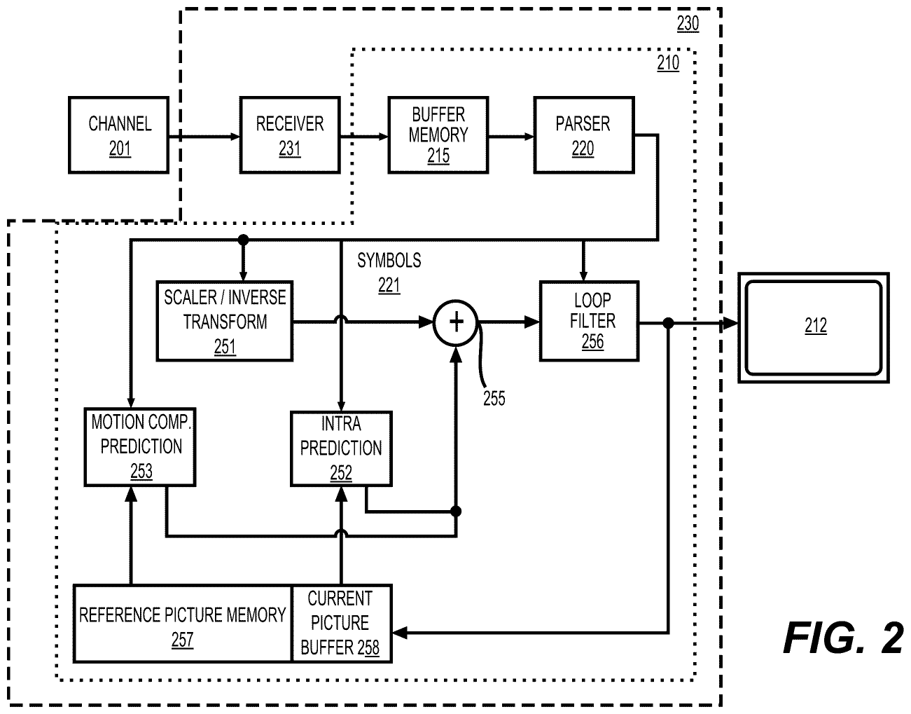

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

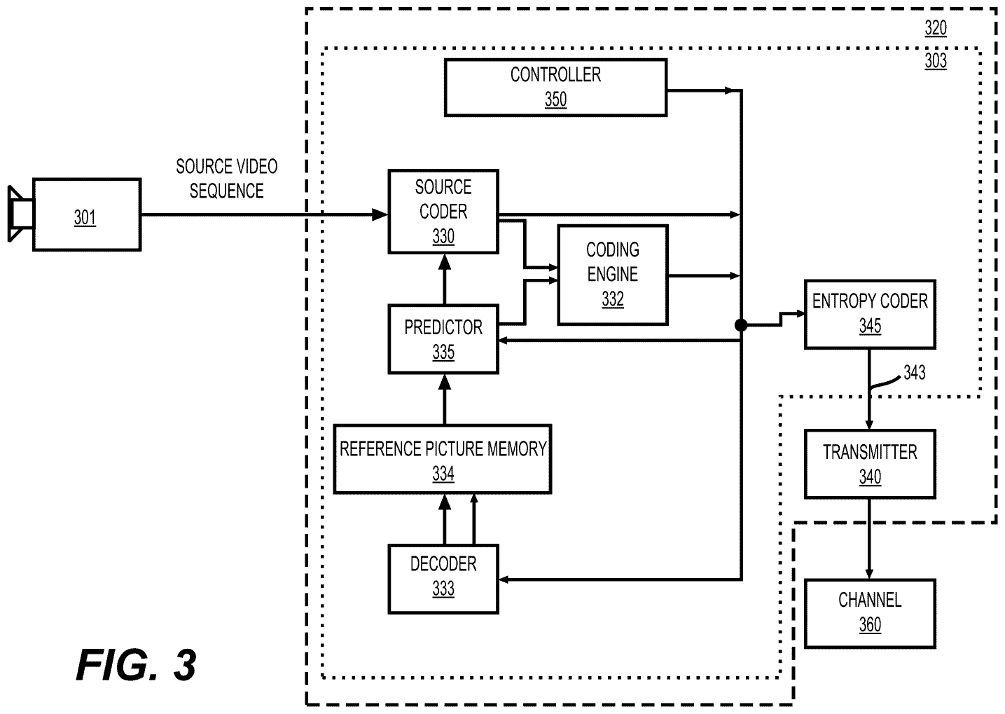

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit—exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Some aspects of the present disclosure provide various techniques of intra picture prediction (also referred to as intra prediction) with one or more in-loop filters. The intra picture prediction can include any suitable intra picture prediction techniques that are used to predict samples in a current block according to reference samples in a same picture as the current block when applying the one or more in-loop filters during the intra picture prediction (e.g., before the whole current picture is reconstructed) do not have data dependency issue. In some examples, the techniques can be used in the template matching based intra predictions. The in-loop filters can be any suitable filters that are applied on the reconstructed samples after the generation of the reconstructed samples and before the reconstructed samples are used for the prediction of other samples in the same picture, such as samples in a current (coding) block.

It is noted that the various techniques disclosed in the present disclosure may be used separately or combined in any order. Further, the various techniques can be implemented in encoder and/or decoder. In the implementations of the various techniques, the encoder and/or the decoder may be implemented by processing circuitry (e.g., one or more processors or one or more integrated circuits). In some examples, the one or more processors execute a program that is stored in a non-transitory computer-readable medium.

In various related examples, the predicted reference samples from neighboring blocks of a current block in the same picture for intra picture prediction of the current block are reconstructed and used for the intra picture prediction of the current block without applying in-loop filters.

For example, in some related intra prediction modes, sample values of the current block in a current picture are predicted from neighboring samples that are already reconstructed (referred to as reference samples) in the current picture. In an example, a predictor block of the current block may be formed using neighboring sample values of already available (e.g., reconstructed) samples. Sample values of neighboring samples may be used to generate samples in the predictor block according to a direction, and the intra picture prediction according to the direction is referred to as angular intra prediction in an example. In the angular intra prediction, a current sample in a current block is predicted using a reference sample (e.g., a prediction sample) or an interpolated reference sample (calculated from a plurality of reference samples).

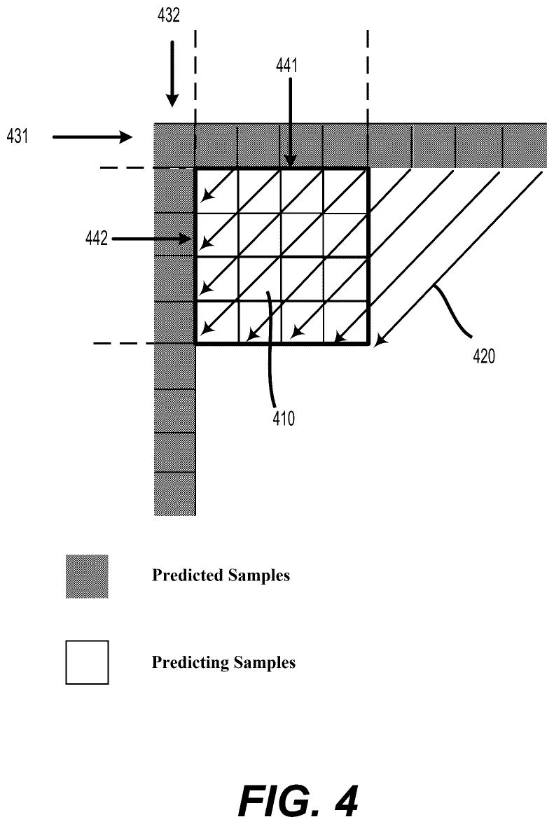

FIG. 4 shows a diagram of angular intra prediction in some examples. In the FIG. 4 example, a current block (also referred to as current coding block) (410) includes a plurality of predicting samples (e.g., 16 predicting samples in the FIG. 4 example). When an angular direction (420) (also referred to as angular mode, and is as shown by arrow lines in FIG. 4) is determined for the current block (410), each of the predicting samples can be predicted according to neighboring predicted samples, such as predicted samples (431) and (432) shown with filled pattern. The neighboring predicted samples can include predicted samples in one or more above rows to the current block (410), such as the above row (431) in FIG. 4, and predicted samples in one or more left columns to the current block (410), such as the left column (432) in FIG. 4.

In the FIG. 4 example, the predicted samples are reconstructed neighboring samples without (or before) applying one or more in-loop filters due to data dependency. For example, deblocking filter is one of the in-loop filters, and an application of the deblocking filter needs samples on both sides of a block edge to be available.

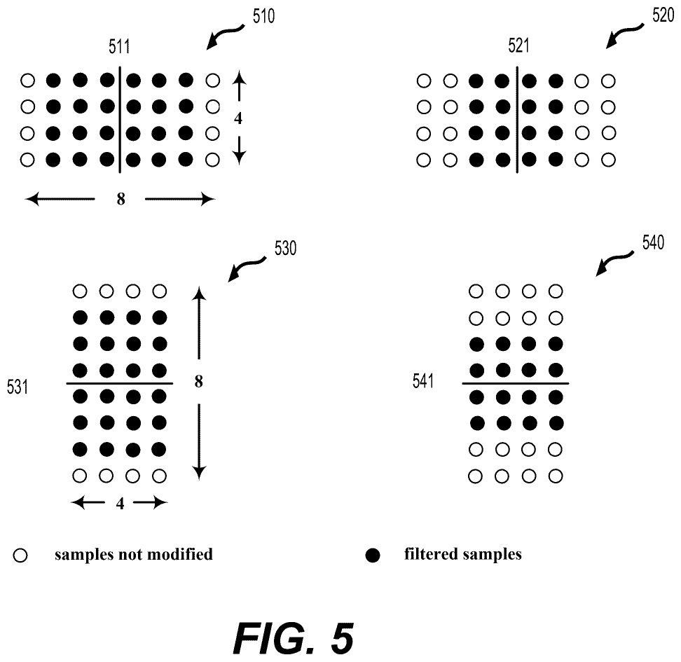

FIG. 5 shows diagrams (510), (520), (530) and (540) for applications of deblocking filters in some examples. For example, in the diagram (510), a deblocking filter is applied to perform a horizontal filtering of a vertical edge (511). Samples on both sides of the vertical edge (511) are involved in the horizontal filtering, and the samples on both sides of the vertical edge (511) can be modified by the horizontal filtering. It is noted that the number of filtered samples (modified samples by the deblocking filter) can be changed based on the filtering parameters. For example, in the diagram (520), a similar deblocking filter is applied to perform a horizontal filtering of a vertical edge (521), the number of modified samples in the diagram (520) is smaller than the example in the diagram (510).

Further, in FIG. 5, in the diagram (530), a deblocking filter is applied to perform a vertical filtering of a horizontal edge (531). Samples on both sides of the horizontal edge (531) are involved in the vertical filtering, the samples on both sides of the horizontal edge (531) and can be modified by the vertical filtering. It is noted that the number of filtered samples (modified samples by the deblocking filter) can be changed based on the filtering parameters. For example, in the diagram (540), a similar deblocking filter is applied to perform a vertical filtering of a horizontal edge (541), the number of modified samples in the diagram (540) is smaller than the example in the diagram (530).

Referring back to the FIG. 4 example, at the time of predicting the current block (410), applying a deblocking filter, such as a vertical filtering of a horizontal edge (441), a horizontal filtering of a vertical edge (442), and the like, suffers data dependency issue. The deblocking filter is not able to be applied since the samples in the current block that are below the horizontal edge (441) or right of the vertical edge (442) are not reconstructed yet.

It is noted that other in-loop filters, such as sample adaptive offset (SAO), adaptive loop filter (ALF), and the like suffer similar data dependency issues as the deblocking filter. Therefore, in some related examples, intra picture prediction uses reference samples before the application of one or more in-loop filters. In some examples, for a current picture, during the encoding/decoding of the current block, reconstructed samples before the application of the one or more in-loop filters are stored in a buffer. After samples of the current pictures are reconstructed, the one or more in-loop filters are applied on the reconstructed samples in the buffer, and the filtered reconstructed samples of the current picture can be further stored by a suitable picture buffer or picture memory.

According to an aspect of the disclosure, in some intra prediction modes, the reference samples of intra prediction are not limited to the direct neighboring samples of the current block. Thus, those intra prediction modes have no data dependency issue of in-loop filters and their reference samples can be applied with one or more in-loop filters before being used as references samples in the further intra prediction.

According to an aspect of the disclosure, a block vector (BV) based technique can be used to perform intra prediction. The block vector based technique can determine a block vector that indicates a position of a reference block for a prediction of samples in a current block, the reference block is in a same picture as the current block. In some examples, the block vector based technique is referred to as intra block copy (IBC).

In some examples, the block vector can be determined using a template-based approach (also referred to as method A). The template-based approach searches a predefined coded (encoded or decoded) areas and determines a reference block to generate the prediction signal for the current block. The position of the reference block is indicated by the block vector. The reference block is also referred to as a similar block, the similarity of the reference block to the current block is determined based on templates in some examples.

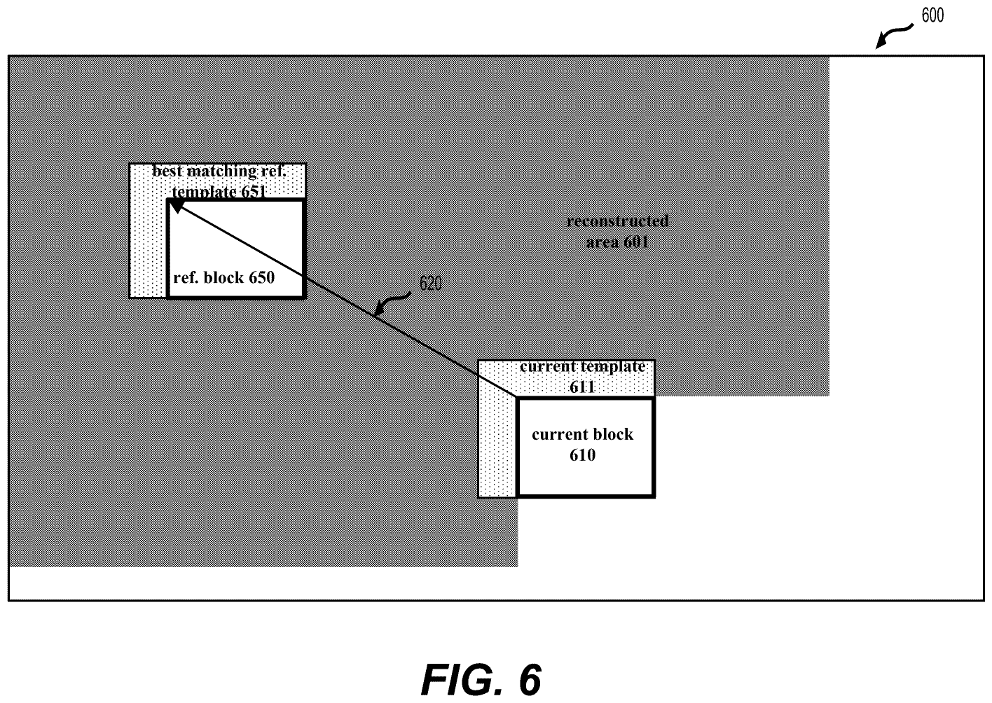

FIG. 6 shows a diagram of a picture (600) using a template-based approach to determine a block vector for intra prediction in some examples. In the FIG. 6 example, for a current block (610) in the picture (600), a current template (611) for the current block (610) is defined. The current template (611) includes one or more neighboring samples of the current block (610) that are already reconstructed. In the FIG. 6 example, the template-based approach searches a predefined coded area, such as the reconstructed area (601), according to the current template (611). For example, the template-based approach searches the reconstructed area (601) to determine a block vector (620) that points to a reference block (650) that has a best match reference template (651) to the current template (611).

In some examples, the block vector is explicitly signaled. In some examples, the block vector is derived implicitly without any signaling, and intra prediction mode is referred to as a block vector based intra prediction mode with a template-based search in an example. For example, respective cost values of candidate reference blocks are calculated based on the similarity between the current template of the current block and respective reference templates of the respective candidate reference blocks. The reference templates of the candidate reference blocks and the current template of the current block have been coded (reconstructed). In some examples, a block vector associated with a candidate reference block that provides a minimum cost value (calculated based on the templates) is used as the block vector for performing intra prediction.

It is noted that, in some examples, the block vector can be any value when the block vector points to a position within a pre-defined search area, including positions that would not cause the data dependency issue for the in-loop filters. Furthermore, the block vector is not limited to align to the position of previous coded blocks (e.g., encoded/decoded blocks). For example, the block vector can point to a position where the reference block overlaps with multiple previous coded blocks.

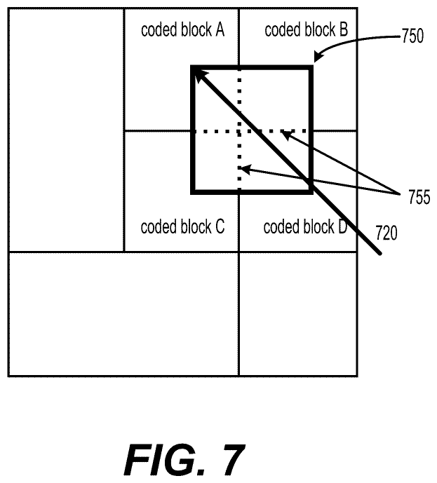

FIG. 7 shows a diagram of a block vector based intra prediction in some examples. In the FIG. 7 example, a block vector (720) points to a reference block (750), the reference block (750) is not aligned with previous coded blocks. For example, the reference block (750) overlaps with coded blocks A-D. In the FIG. 7 example, when a current block is predicted according to the reference block (750), the current block can suffer block artifacts, such as at locations (755) that are edges between the coded blocks A-D, when the reference samples of coded blocks A-D are not deblocked.

According to another aspect of the disclosure, another intra prediction technique that is referred to as template-based intra mode derivation (also referred to as method B) is not block vector based intra prediction and also has no data dependency issue for the reference samples. In some examples, when the template block and the current block (also referred to as current coding block) are well correlated, the intra prediction mode (e.g., the angular mode) applied for the template might give a well indication for the current block. For example, the current block and neighboring samples of the current block share similar texture characteristics. Thus, neighboring reconstructed samples of the current block are employed to predict the current block. In an example, the method B includes template-based intra prediction mode derivation (TIMD) technique that can be applied to the current block. When the current template (of the current block) and the current block are well correlated, the intra prediction mode applied to the current template can give a good indication for the current block.

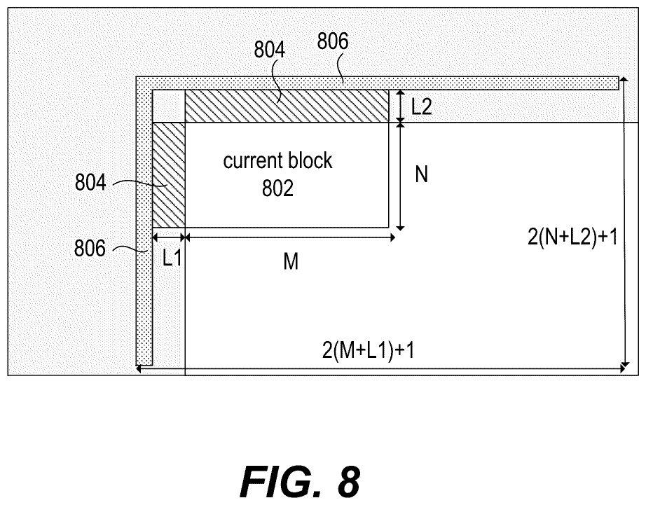

FIG. 8 shows a diagram for a template based intra mode derivation in some examples. In the FIG. 8 example, neighboring reconstructed samples of a current block (also referred to as current CU) (802) can form a current template (804). The current template (804) can have any suitable shape and include any suitable number of samples. The current template (804) can be adjacent to the current block (802). In an aspect, the current template (804) includes reconstructed samples. In the example shown in FIG. 8, the current template (804) has an “L” shape and includes both a top template and a left template, the top template includes a row above the current block (802) and the left template includes a column left of the current block (802). In an example, the current template (804) includes a top-left corner that is adjacent to the current block (802). In an example, the current template (804) includes the top template that is above the current block (802). In an example, the current template (804) includes the left template that is to the left of the current block (802).

In an example, reference samples (806) can be adjacent to the current template (804). In an example, the reference samples (806) can include at least one line (e.g., at least one row and/or at least one column) of samples.

In some examples, according to the method B, the template based intra mode derivation can include one or more of the following steps:

In a step 1, a group of samples can be defined as reference of the current template. For example, in FIG. 8, the group of samples that are defined as the reference samples for the current template (804) are shown by reference samples (806), the reference samples (806) are used to generate a prediction signal of the current template (804).

In a step 2, an intra prediction mode (also referred to as intra mode, angular mode in some examples) can be exercised (e.g., can be applied) to the reference samples (806) of the current template (804) to generate the prediction signal, e.g., the prediction of the current template (804). In an example, a pre-defined intra prediction mode set can include pre-defined intra modes (also referred to as pre-defined intra prediction modes), and the intra prediction mode that is applied to the reference samples (806) of the current template (804) is one of the pre-defined intra modes.

In a step 3, a cost of the prediction signal of the current template (804) with regard to a reconstruction signal of the current template (804) can be calculated. In an example, the reconstruction signal of the current template (804) includes reconstructed samples in the current template (804).

In an example, the cost is calculated as a sum of absolute transformed differences (SATD) cost between the prediction signal of the current template (804) and the reconstruction signal of the current template (804). In another example, the cost is calculated as a mean removal sum of absolute differences (MRSAD) between the prediction signal of the current template (804) and the reconstruction signal of the current template (804).

In a step 4, the steps 2 and 3 can be repeated for another mode in the pre-defined intra prediction mode set. The pre-defined intra modes can be sorted (e.g., ranked) based on the respective costs (e.g., the SATD costs or the MRSAD costs).

In a step 5, a mode with the least cost (e.g., the least SATD cost) is chosen as the prediction mode for the current block or the current CU (802). For the convenience of description, the prediction mode that is determined can be referred to as a template-based intra mode.

According to an aspect of the disclosure, the template based intra mode derivation in method B may be not accurate due to the samples within the current template and the reference samples of the current template have not been applied with in-loop filters.

Some aspects of the present disclosure provide techniques of using in-loop filters in intra prediction. In some examples, when a data dependency requirement associated with the one or more in-loop filters is satisfied by one or more reconstructed samples for an intra prediction mode of a current block in a current picture, encoder/decoder can apply one or more in-loop filters on one or more reconstructed samples in the current picture to generate one or more filtered reconstructed samples; and can reconstruct the current block using the intra prediction mode and based on the one or more filtered reconstructed samples.

In the following description, a reference block vector refers to the block vector derived from neighboring coded information or explicitly signaled; a reference block refers to a block that is pointed by the block vector from the current block (e.g., reference block (650) in FIG. 6). In the following description, an in-loop filter includes but not limited to a deblocking filter, a sample adaptive offset (SAO), an adaptive loop filter (ALF), bilateral filter, and any variations. In the following description, an in-loop filter can be applied in implementations where the data dependency issue is addressed for the in-loop filter. For example, the in-loop filter is applied when a determination of no data dependency issue is made.

According to some aspects of the disclosure, one or more in-loop filters are applied on the reference samples before intra prediction (e.g., in an implementation according to the method A) or one or more in-loop filters are applied to the template of current coding block to improve intra prediction accuracy (e.g., in an implementation according to the method B).

According to an aspect of the disclosure, when a block vector (e.g., in an implementation according to the method A) points to a reference block that satisfies data dependency requirements of the one or more in-loop filters, reference samples in the reference block are applied with the one or more filters first and then intra prediction using the block vector based intra picture prediction is performed.

In some examples, the behavior of one or more filters can include but not limited to be deblocking filter, bilateral filter, shape-adaptive filter, wiener filter, . . . , etc.

In some examples, the behavior of one or more filters can include but not limited to be a combination of existing intra prediction tool (e.g., smoothing filter or interpolation filter) with the one or more of in-loop filters, such as deblocking filter, bilateral filter, shape-adaptive filter, wiener filter, . . . , etc. In some examples, the existing intra prediction tool includes pre-filters that are applied on reference samples before using the reference samples for prediction, the pre-filters include smoothing filter, interpolation filter and the like. In some examples, reconstructed samples without being applied with in-loop filters are buffered. When a block vector that points to a reference block is determined, the block vector is checked to determine that the reference block has no data dependency issue, then one or more in-loop filters are applied to the buffered reconstructed samples of the reference block to generate intermediate filtered reference samples. Further, the pre-filters can be applied on the intermediate filtered reference samples to generate filtered reference samples, and the filtered reference samples are used to generate the predictor (also referred to as prediction signal for the current block.

In some examples, the coding information of the reference samples, such as transform block size, prediction mode, and the like can be used for one or more filters. For example, the coding information includes partition information. When the partition information indicates that the reference block overlaps with multiple coded blocks (e.g., FIG. 7), then a deblocking filter can be applied on reference samples in the reference block. When the partition information indicates that the reference block aligns with a coded block, then no need to apply the deblocking filter on reference samples.

In some examples, when the block vector is derived implicitly by searching for the most similar block using template (also referred to as a block vector based intra prediction mode with a template-based search), reference samples within the pre-defined area are firstly applied with one or more in-loop filters before the search starts. In some examples, reconstructed samples without being applied with in-loop filters are buffered. Before the search starts, one or more in-loop filters are applied to the reconstructed samples in the pre-defined area to generate filtered samples of the pre-defined area. The search of the block vector in the pre-defined area is then performed based on the filtered samples of the pre-defined area.

In some examples, when the block vector is derived by searching for the most similar block using template based approach (also referred to as a block vector based intra prediction mode with a template-based search), samples within the current template are applied with one or more in-loop filters before search starts. In some examples, reconstructed samples without being applied with in-loop filters are buffered. Before the search starts, one or more in-loop filters are applied to the reconstructed samples of the current template to generate filtered samples of the current template. The search of the block vector in the pre-defined area is then performed in the pre-defined area based on the filtered samples of the current template.

In some examples, the reference samples with the pre-defined search area and the samples within the current template are not modified by one or more in-loop filters during the search stage. The one or more in-loop filters are applied only for the most similar blocks. In some examples, reconstructed samples without being applied with in-loop filters are buffered. Before the search starts, no in-loop filter is applied to the reconstructed samples. The search of the block vector in the pre-defined area is then performed based on the reconstructed samples without being filtered by in-loop filters. In an example, two or more block vectors that point to the most similar reference templates of the current template are determined, and then one or more in-loop filters are applied to the most similar reference templates of the current complete. Further, the block vector that points to the best matching reference template (after the filtering by the one or more in-loop filters) is determined to be the search result. In an example, the one or more in-loop filters are applied to the reference block of the current block that is pointed by the block vector.

In another example, the search of the block vector in the pre-defined area is then performed based on the reconstructed samples without being filtered by in-loop filters. In an example, after the block vector that points to the most similar reference template of the current template is determined, one or more in-loop filters can be applied on the reference block that is pointed by the block vector to generate a prediction of the current block.

In some examples, when a reference block crosses (overlaps with) multiple coded blocks, such as shown in FIG. 7, a deblocking filter is applied to the reference samples in the reference block to reduce the blocking artifact along the edges within the reference block. The filtered reference block is used to generate a prediction of the current block.

In some examples, when a block vector is explicitly signaled, the samples within the pointed area are applied with one or more in-loop filters. The filtered samples in the pointed area by the block vector is then used to generate a prediction of the current block.

According to another aspect of the disclosure, for the template based intra mode derivation of the method B, the template and the reference of the template in method B are firstly applied with one or more in-loop filters before using the template to derive intra prediction mode (e.g., an angular intra mode). In some examples, reconstructed samples without being applied with in-loop filters are buffered. To derive intra mode of the current block, one or more in-loop filters are applied to the template of the current block (e.g., the template (804) in FIG. 8), and the reference of the template (e.g., the reference (806) of the template (804)) to generate filtered template and the filtered reference. The filtered template and the filtered reference are then used to derive the intra mode for the current block.

According to another aspect of the disclosure, the results after applying one or more in-loop filters in the method A and the method B are volatile and would not be used for other intra prediction approaches. In some examples, reconstructed samples without being applied with in-loop filters are buffered. When one or more in-loop filters are applied to one or more reconstructed samples in the method A or the method B, the filtered samples are not buffered (e.g., not replacing the reconstructed samples without being applied with in-loop filters).

According to another aspect of the disclosure, the results after applying one or more in-loop filters in the method A and the method B are stored in decoded picture buffer and they are skipped by the in-loop filter stage after reconstruction. In an example, reconstructed samples without being applied with in-loop filters are buffered. When one or more in-loop filters are applied to one or more reconstructed samples in the method A or the method B, the filtered samples are stored in the decoded picture buffer. After the reconstruction of the current picture, to apply one or more in-loop filters on reconstructed samples of the current picture, the in-loop filters can be skipped for filtered samples that already in the decoded picture buffer.

In another example, reconstructed samples without being applied with in-loop filters are buffered. When a first in-loop filter is applied to one or more reconstructed samples in the method A or the method B, the filtered samples are stored in the decoded picture buffer. After the reconstruction of the current picture, to apply the first in-loop filter on reconstructed samples of the current picture, the first in-loop filter can be skipped for filtered samples that are already in the decoded picture buffer. In some examples, a second in-loop filter can be applied to the filtered samples that are already in the decoded picture buffer.

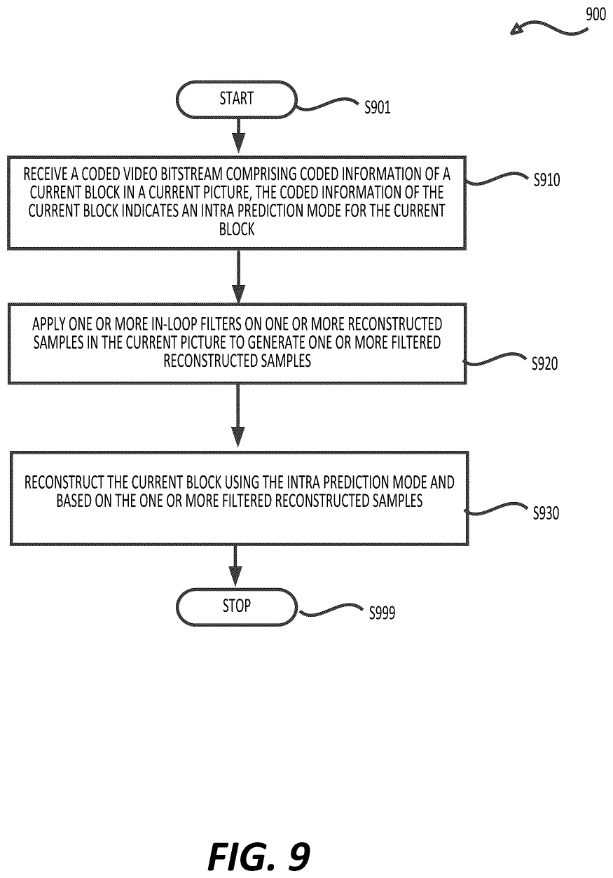

FIG. 9 shows a flow chart outlining a process (900) according to an aspect of the disclosure. The process (900) can be used in a video decoder. In various aspects, the process (900) is executed by processing circuitry, such as the processing circuitry that performs functions of the video decoder (110), the processing circuitry that performs functions of the video decoder (210), and the like. In some aspects, the process (900) is implemented in software instructions, thus when the processing circuitry executes the software instructions, the processing circuitry performs the process (900). The process starts at (S901) and proceeds to (S910).

At (S910), a coded video bitstream is received. The coded video bitstream includes coded information of a current block in a current picture, the coded information of the current block indicates an intra prediction mode for the current block.

At (S920), one or more in-loop filters are applied on one or more reconstructed samples in the current picture to generate one or more filtered reconstructed samples.

At (S930), the current block is reconstructed using the intra prediction mode and based on the one or more filtered reconstructed samples.

In some examples, to apply the one or more in-loop filters, a determination that a data dependency requirement associated with the one or more in-loop filters is satisfied by the one or more reconstructed samples is made.

In some examples, the one or more in-loop filters include at least one of a deblocking filter, a bilateral filter, a shape adaptive filter, a wiener filter, a sample adaptive offset (SAO) filter, and/or an adaptive loop filter (ALF).

According to an aspect of the disclosure, the intra prediction mode is a block vector based intra prediction mode. In some examples, a block vector that points to a reference block of the current block in the current picture is determined, the reference block includes reference samples corresponding to the one or more reconstructed samples. At least the one or more in-loop filters are applied on the reference samples to generate filtered reference samples. The current block is reconstructed based on the filtered reference samples.

In some examples, the one or more in-loop filters are applied on the reference samples in the current picture to generate intermediate filtered reference samples. Further, at least one of a smoothing filter and/or an interpolation filter is applied on the intermediate filtered reference samples to generate the filtered reference samples.

In some examples, whether to apply the one or more in-loop filters on the reference samples can be determined based on coding information of the reference samples. In an example, when partition information indicates that the reference block crosses an edge of two coded blocks (e.g., decoded blocks), to apply the one or more in-loop filters on the reference block can be determined. In another example, when partition information indicates that the reference block aligns with a coded block (e.g., decoded block), no need to apply the one or more in-loop filters on the reference block can be determined.

In some examples, the intra prediction mode is a block vector based intra prediction mode with a template-based search. The one or more in-loop filters are applied on the one or more reconstructed samples in a search area of the current picture to generate the one or more filtered reconstructed samples. The search area is searched based on the one or more filtered reconstructed samples to determine a block vector that points to a reference block of the current block in the current picture.

In some examples, the intra prediction mode is a block vector based intra prediction mode with a template-based search. The one or more in-loop filters are applied on the one or more reconstructed samples that form a current template of the current block to generate a filtered current template of the current block. A search area is searched based on the filtered current template of the current block to determine a block vector that points to a reference block of the current block in the current picture.

In some examples, the intra prediction mode is a block vector based intra prediction mode with a template-based search. Respective cost values of a plurality of candidate reference blocks in a search area are calculated, a cost value of a candidate reference block in the plurality of candidate reference blocks is calculated based on a first template of the candidate reference block and a second template of the current block. Most similar templates are determined based on the respective cost values. The one or more in-loop filters are applied on the most similar templates to generate filtered most similar templates. A block vector that points to a reference block of the current block in the current picture is determined based on the filtered most similar templates. Further, the one or more in-loop filters can be applied to the reference block that is pointed by the block vector.

In some examples, the intra prediction mode is a block vector based intra prediction mode with a template-based search. Respective cost values of a plurality of candidate reference blocks in a search area are calculated, a cost value of a candidate reference block in the plurality of candidate reference blocks is calculated based on a first template of the candidate reference block and a second template of the current block. A most similar block in the plurality of candidate reference blocks is determined based on the respective cost values. The one or more in-loop filters are applied on the most similar block to generate a prediction of the current block.

In some examples, the reference block is determined to cross at least an edge of two coded blocks. Then, a deblocking filter is applied on at least neighboring samples of the edge in the reference block.

In some examples, the block vector is explicitly signaled, for example, the block vector can be decoded from the coded video bitstream. In some examples, the block vector can be derived at the decoder side, for example using the template based search.

According to an aspect of the disclosure, the intra prediction mode is based on a template based intra mode derivation, the one or more reconstructed samples include first one or more samples in a template of the current block, and second one or more samples in a reference portion of the template of the current block. In some examples, the one or more in-loop filters are applied on the first one or more samples in the template of the current block to generate filtered first one or more samples, and the one or more in-loop filters are applied on the second one or more samples in the reference portion of the template of the current block to generate filtered second one or more samples. An intra mode (e.g., angular intra mode) is derived based on the filtered first one or more samples and the filtered second one or more samples.

In some examples, the current block is a first current block, the one or more reconstructed samples (e.g., before applying the one or more in-loop filters) are stored in a buffer. The one or more filtered reconstructed samples can be discarded (e.g., being volatile) after the current block has been reconstructed. A second current block in the current picture can be reconstructed based on at least one of the one or more reconstructed samples that is stored in the buffer.

In some examples, the one or more filtered reconstructed samples are stored in a picture buffer (e.g., being non-volatile). Further, in response to an application of the one or more in-loop filters to the picture buffer, the application of the one or more in-loop filters on the one or more filtered reconstructed samples is skipped in an example.

Then, the process proceeds to (S999) and terminates.

The process (900) can be suitably adapted. Step(s) in the process (900) can be modified and/or omitted. Additional step(s) can be added. Any suitable order of implementation can be used.

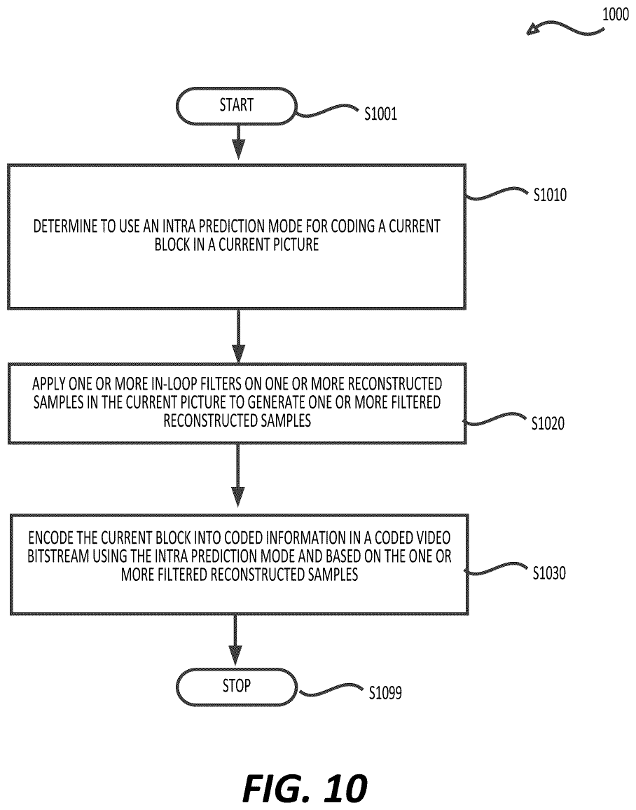

FIG. 10 shows a flow chart outlining a process (1000) according to an aspect of the disclosure. The process (1000) can be used in a video encoder. In various aspects, the process (1000) is executed by processing circuitry, such as the processing circuitry that performs functions of the video encoder (103), the processing circuitry that performs functions of the video encoder (303), and the like. In some aspects, the process (1000) is implemented in software instructions, thus when the processing circuitry executes the software instructions, the processing circuitry performs the process (1000). The process starts at (S1001) and proceeds to (S1010).

At (S1010), to use an intra prediction mode for coding a current block in a current picture is determined.

At (S1020), one or more in-loop filters are applied on one or more reconstructed samples in the current picture to generate one or more filtered reconstructed samples.

At (S1030), the current block is encoded into coded information in a coded video bitstream using the intra prediction mode and based on the one or more filtered reconstructed samples.

In some examples, to apply the one or more in-loop filters, a data dependency requirement associated with the one or more in-loop filters is determined to be satisfied by the one or more reconstructed samples.

In some examples, the one or more in-loop filters include at least one of a deblocking filter, a bilateral filter, a shape adaptive filter, a wiener filter, a sample adaptive offset (SAO) filter, and/or an adaptive loop filter (ALF).

According to an aspect of the disclosure, the intra prediction mode is a block vector based intra prediction mode. For example, a block vector that points to a reference block of the current block in the current picture is determined, the reference block includes reference samples that include the one or more reconstructed samples. In some examples, at least the one or more in-loop filters are applied on the reference samples to generate filtered reference samples. The current block is reconstructed based on the filtered reference samples.

In an example, the one or more in-loop filters are applied on the reference samples in the current picture to generate intermediate filtered reference samples. Further, at least one of a smoothing filter and/or an interpolation filter can be applied on the intermediate filtered reference samples to generate the filtered reference samples.

In some examples, whether to apply the one or more in-loop filters on the reference samples can be determined based on coding information of the reference samples. In an example, when partition information indicates that the reference block crosses an edge of two coded blocks (e.g., encoded blocks), to apply the one or more in-loop filters on the reference block can be determined. In another example, when partition information indicates that the reference block aligns with a coded block (e.g., encoded block), no need to apply the one or more in-loop filters on the reference block can be determined.

According to an aspect of the disclosure, the intra prediction mode is a block vector based intra prediction mode with a template-based search. The one or more in-loop filters are applied on the one or more reconstructed samples in a search area of the current picture to generate the one or more filtered reconstructed samples. The search area is searched based on the one or more filtered reconstructed samples to determine a block vector that points to a reference block of the current block in the current picture.

In some examples, the intra prediction mode is a block vector based intra prediction mode with a template-based search, the one or more in-loop filters are applied on the one or more reconstructed samples that form a current template of the current block to generate a filtered current template of the current block. A search area is searched based on the filtered current template of the current block to determine a block vector that points to a reference block of the current block in the current picture.

In some examples, the intra prediction mode is a block vector based intra prediction mode with a template-based search, respective cost values of a plurality of candidate reference blocks in a search area are calculated. A cost value of a candidate reference block in the plurality of candidate reference blocks is calculated based on a first template of the candidate reference block and a second template of the current block. Most similar templates are determined based on the respective cost values. The one or more in-loop filters are applied on the most similar templates to generate filtered most similar templates. A block vector that points to a reference block of the current block in the current picture is determined based on the filtered most similar templates. Further, the one or more in-loop filters can be applied to the reference block that is pointed by the block vector.

In some examples, the intra prediction mode is a block vector based intra prediction mode with a template-based search. Respective cost values of a plurality of candidate reference blocks in a search area are calculated, a cost value of a candidate reference block in the plurality of candidate reference blocks is calculated based on a first template of the candidate reference block and a second template of the current block. A most similar block in the plurality of candidate reference blocks is determined based on the respective cost values. The one or more in-loop filters are applied on the most similar block to generate a prediction of the current block.

In some examples, the reference block crossing at least an edge of two coded blocks is determined, and then a deblocking filter is applied on at least neighboring samples of the edge in the reference block.

In some examples, the block vector is explicitly signaled, for example, the block vector is encoded into the coded video bitstream. In some examples, the block vector can be derived at the decoder side, for example using the template based search.

According to an aspect of the disclosure, the intra prediction mode is based on a template based intra mode derivation, the one or more reconstructed samples include first one or more samples in a template of the current block, and second one or more samples in a reference portion of the template of the current block. In some examples, the one or more in-loop filters are applied on the first one or more samples in the template of the current block to generate filtered first one or more samples, and the one or more in-loop filters are applied on the second one or more samples in the reference portion of the template of the current block to generate filtered second one or more samples. An intra mode (e.g., angular intra mode) is derived based on the filtered first one or more samples and the filtered second one or more samples.

In some examples, the current block is a first current block, the one or more reconstructed samples (e.g., before applying the one or more in-loop filters) are stored in a buffer. The one or more filtered reconstructed samples can be discarded (e.g., being volatile) after the current block has been reconstructed. A second current block in the current picture can be reconstructed based on at least one of the one or more reconstructed samples that is stored in the buffer.

In some examples, the one or more filtered reconstructed samples are stored in a picture buffer (e.g., being non-volatile). Further, in response to an application of the one or more in-loop filters to the picture buffer, the application of the one or more in-loop filters on the one or more filtered reconstructed samples is skipped in an example.

Then, the process proceeds to (S1099) and terminates.

The process (1000) can be suitably adapted. Step(s) in the process (1000) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes coded information of a current block in a current picture, the coded information of the current block indicates an intra prediction mode for the current block. The format rule specifies that one or more in-loop filters are applied on one or more reconstructed samples in the current picture to generate one or more filtered reconstructed samples; and the current block is reconstructed using the intra prediction mode and based on the one or more filtered reconstructed samples.

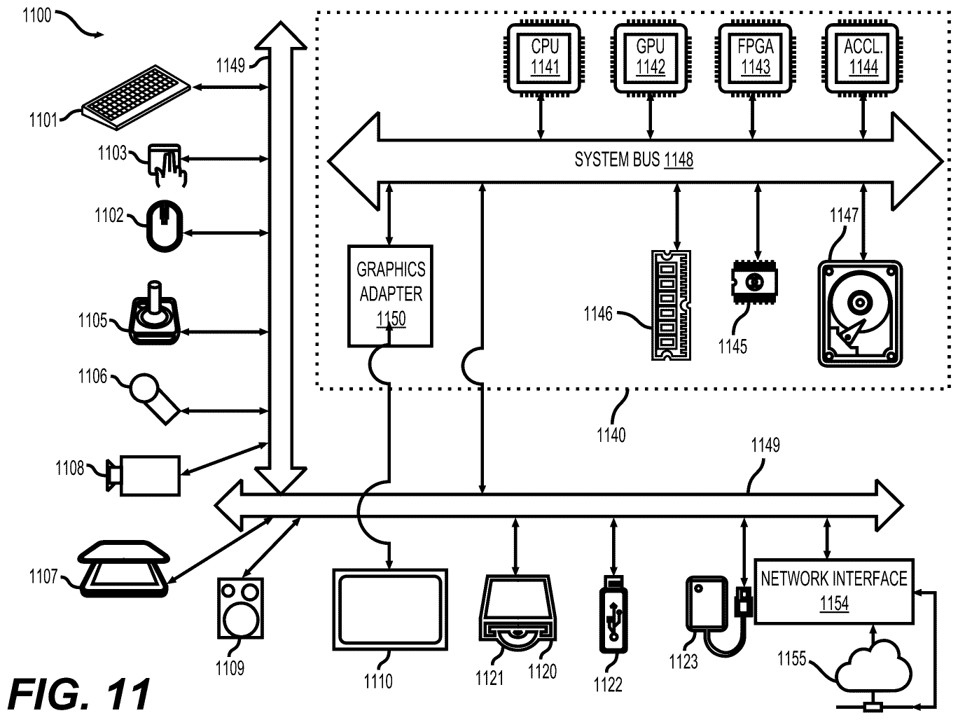

The techniques described above, can be implemented as computer software using computer-readable instructions and physically stored in one or more computer-readable media. For example, FIG. 11 shows a computer system (1100) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 11 for computer system (1100) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1100).

Computer system (1100) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1101), mouse (1102), trackpad (1103), touch screen (1110), data-glove (not shown), joystick (1105), microphone (1106), scanner (1107), camera (1108).

Computer system (1100) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1110), data-glove (not shown), or joystick (1105), but there can also be tactile feedback devices that do not serve as input devices), audio output devices (such as: speakers (1109), headphones (not depicted)), visual output devices (such as screens (1110) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1100) can also include human accessible storage devices and their associated media such as optical media including CD/DVD ROM/RW (1120) with CD/DVD or the like media (1121), thumb-drive (1122), removable hard drive or solid state drive (1123), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1100) can also include an interface (1154) to one or more communication networks (1155). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1149) (such as, for example USB ports of the computer system (1100)); others are commonly integrated into the core of the computer system (1100) by attachment to a system bus as described below (for example Ethernet interface into a PC computer system or cellular network interface into a smartphone computer system). Using any of these networks, computer system (1100) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1140) of the computer system (1100).

The core (1140) can include one or more Central Processing Units (CPU) (1141), Graphics Processing Units (GPU) (1142), specialized programmable processing units in the form of Field Programmable Gate Areas (FPGA) (1143), hardware accelerators for certain tasks (1144), graphics adapters (1150), and so forth. These devices, along with Read-only memory (ROM) (1145), Random-access memory (1146), internal mass storage such as internal non-user accessible hard drives, SSDs, and the like (1147), may be connected through a system bus (1148). In some computer systems, the system bus (1148) can be accessible in the form of one or more physical plugs to enable extensions by additional CPUs, GPU, and the like. The peripheral devices can be attached either directly to the core's system bus (1148), or through a peripheral bus (1149). In an example, the screen (1110) can be connected to the graphics adapter (1150). Architectures for a peripheral bus include PCI, USB, and the like.

CPUs (1141), GPUs (1142), FPGAs (1143), and accelerators (1144) can execute certain instructions that, in combination, can make up the aforementioned computer code. That computer code can be stored in ROM (1145) or RAM (1146). Transitional data can also be stored in RAM (1146), whereas permanent data can be stored for example, in the internal mass storage (1147). Fast storage and retrieve to any of the memory devices can be enabled through the use of cache memory, that can be closely associated with one or more CPU (1141), GPU (1142), mass storage (1147), ROM (1145), RAM (1146), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1100), and specifically the core (1140) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1140) that are of non-transitory nature, such as core-internal mass storage (1147) or ROM (1145). The software implementing various aspects of the present disclosure can be stored in such devices and executed by core (1140). A computer-readable medium can include one or more memory devices or chips, according to particular needs. The software can cause the core (1140) and specifically the processors therein (including CPU, GPU, FPGA, and the like) to execute particular processes or particular parts of particular processes described herein, including defining data structures stored in RAM (1146) and modifying such data structures according to the processes defined by the software. In addition or as an alternative, the computer system can provide functionality as a result of logic hardwired or otherwise embodied in a circuit (for example: accelerator (1144)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of”' in the disclosure is intended to include any one or a combination of the recited elements. For example, references to at least one of A, B, or C; at least one of A, B, and C; at least one of A, B, and/or C; and at least one of A to Care intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1). A method of video decoding, including: receiving a coded video bitstream including coded information of a current block in a current picture, the coded information of the current block indicating an intra prediction mode for the current block; applying one or more in-loop filters on one or more reconstructed samples in the current picture to generate one or more filtered reconstructed samples; and reconstructing the current block using the intra prediction mode and based on the one or more filtered reconstructed samples.

(2). The method of feature (1), in which the applying includes: determining that a data dependency requirement associated with the one or more in-loop filters is satisfied by the one or more reconstructed samples.

(3). The method of any of features (1) to (2), in which the one or more in-loop filters include at least one of a deblocking filter, a bilateral filter, a shape adaptive filter, a wiener filter, a sample adaptive offset (SAO) filter, and/or an adaptive loop filter (ALF).

(4). The method of any of features (1) to (3), in which the intra prediction mode is a block vector based intra prediction mode, and the method includes: determining a block vector that points to a reference block of the current block in the current picture, the reference block including reference samples corresponding to the one or more reconstructed samples; applying at least the one or more in-loop filters on the reference samples to generate filtered reference samples; and reconstructing the current block based on the filtered reference samples.

(5). The method of any of features (1) to (4), in which the applying includes: applying the one or more in-loop filters on the reference samples in the current picture to generate intermediate filtered reference samples; and applying at least one of a smoothing filter and/or an interpolation filter on the intermediate filtered reference samples to generate the filtered reference samples.

(6). The method of any of features (1) to (5), further including: determining whether to apply the one or more in-loop filters on the reference samples based on coding information of the reference samples.

(7). The method of any of features (1) to (6), in which the intra prediction mode is a block vector based intra prediction mode with a template-based search, and the method includes: applying the one or more in-loop filters on the one or more reconstructed samples in a search area of the current picture to generate the one or more filtered reconstructed samples; and searching in the search area based on the one or more filtered reconstructed samples to determine a block vector that points to a reference block of the current block in the current picture.

(8). The method of any of features (1) to (7), in which the intra prediction mode is a block vector based intra prediction mode with a template-based search, and the method includes: applying the one or more in-loop filters on the one or more reconstructed samples that form a current template of the current block to generate a filtered current template of the current block; and searching in a search area based on the filtered current template of the current block to determine a block vector that points to a reference block of the current block in the current picture.

(9). The method of any of features (1) to (8), in which the intra prediction mode is a block vector based intra prediction mode with a template-based search, and the method includes: calculating, respective cost values of a plurality of candidate reference blocks in a search area, a cost value of a candidate reference block in the plurality of candidate reference blocks being calculated based on a first template of the candidate reference block and a second template of the current block; determining most similar templates based on the respective cost values; applying the one or more in-loop filters on the most similar templates to generate filtered most similar templates; and determining a block vector that points to a reference block of the current block in the current picture based on the filtered most similar templates.

(10). The method of any of features (1) to (9), in which the intra prediction mode is a block vector based intra prediction mode with a template-based search, and the method includes: calculating, respective cost values of a plurality of candidate reference blocks in a search area, a cost value of a candidate reference block in the plurality of candidate reference blocks being calculated based on a first template of the candidate reference block and a second template of the current block; determining a most similar block in the plurality of candidate reference blocks based on the respective cost values; and applying the one or more in-loop filters on the most similar block to generate a prediction of the current block.

(11). The method of any of features (1) to (10), in which the applying includes: determining that the reference block crosses at least an edge of two coded blocks; and applying a deblocking filter on at least neighboring samples of the edge in the reference block.

(12). The method of any of features (1) to (11), in which the determining the block vector includes: decoding the block vector that is signaled in the coded video bitstream.

(13). The method of any of features (1) to (12), in which the intra prediction mode is based on a template based intra mode derivation, the one or more reconstructed samples includes first one or more samples in a template of the current block, and second one or more samples in a reference portion of the template of the current block, and the method includes: applying the one or more in-loop filters on the first one or more samples in the template of the current block to generate filtered first one or more samples; applying the one or more in-loop filters on the second one or more samples in the reference portion of the template of the current block to generate filtered second one or more samples; and deriving an intra mode based on the filtered first one or more samples and the filtered second one or more samples.

(14). The method of any of features (1) to (13), in which the current block is a first current block, and the method includes: storing the one or more reconstructed samples in a buffer; discarding the one or more filtered reconstructed samples after the current block has been reconstructed; and reconstructing a second current block in the current picture based on at least one of the one or more reconstructed samples that is stored in the buffer.

(15). The method of any of features (1) to (14), further including: storing the one or more filtered reconstructed samples in a picture buffer; and in response to an application of the one or more in-loop filters to the picture buffer, skipping the application of the one or more in-loop filters on the one or more filtered reconstructed samples.

(16). A method of video encoding, including: determining to use an intra prediction mode for coding a current block in a current picture; applying one or more in-loop filters on one or more reconstructed samples in the current picture to generate one or more filtered reconstructed samples; and encoding the current block into coded information in a coded video bitstream using the intra prediction mode and based on the one or more filtered reconstructed samples.

(17). The method of feature (16), in which the applying includes: determining that a data dependency requirement associated with the one or more in-loop filters is satisfied by the one or more reconstructed samples.

(18). The method of any of features (16) to (17), in which the one or more in-loop filters include at least one of a deblocking filter, a bilateral filter, a shape adaptive filter, a wiener filter, a sample adaptive offset (SAO) filter, and/or an adaptive loop filter (ALF).

(19). The method of any of features (16) to (18), in which the intra prediction mode is a block vector based intra prediction mode, and the method includes: determining a block vector that points to a reference block of the current block in the current picture, the reference block including reference samples corresponding to the one or more reconstructed samples; applying at least the one or more in-loop filters on the reference samples to generate filtered reference samples; and reconstructing the current block based on the filtered reference samples.

(20). The method of any of features (16) to (19), in which the applying includes: applying the one or more in-loop filters on the reference samples in the current picture to generate intermediate filtered reference samples; and applying at least one of a smoothing filter and/or an interpolation filter on the intermediate filtered reference samples to generate the filtered reference samples.

(21). The method of any of features (16) to (20), further including: determining whether to apply the one or more in-loop filters on the reference samples based on coding information of the reference samples.

(22). The method of any of features (16) to (21), in which the intra prediction mode is a block vector based intra prediction mode with a template-based search, and the method includes: applying the one or more in-loop filters on the one or more reconstructed samples in a search area of the current picture to generate the one or more filtered reconstructed samples; and searching in the search area based on the one or more filtered reconstructed samples to determine a block vector that points to a reference block of the current block in the current picture.

(23). The method of any of features (16) to (22), in which the intra prediction mode is a block vector based intra prediction mode with a template-based search, and the method includes: applying the one or more in-loop filters on the one or more reconstructed samples that form a current template of the current block to generate a filtered current template of the current block; and searching in a search area based on the filtered current template of the current block to determine a block vector that points to a reference block of the current block in the current picture.

(24). The method of any of features (16) to (23), in which the intra prediction mode is a block vector based intra prediction mode with a template-based search, and the method includes: calculating, respective cost values of a plurality of candidate reference blocks in a search area, a cost value of a candidate reference block in the plurality of candidate reference blocks being calculated based on a first template of the candidate reference block and a second template of the current block; determining most similar templates based on the respective cost values; applying the one or more in-loop filters on the most similar templates to generate filtered most similar templates; and determining a block vector that points to a reference block of the current block in the current picture based on the filtered most similar templates.

(25). The method of any of features (16) to (24), in which the intra prediction mode is a block vector based intra prediction mode with a template-based search, and the method includes: calculating, respective cost values of a plurality of candidate reference blocks in a search area, a cost value of a candidate reference block in the plurality of candidate reference blocks being calculated based on a first template of the candidate reference block and a second template of the current block; determining a most similar block in the plurality of candidate reference blocks based on the respective cost values; and applying the one or more in-loop filters on the most similar block to generate a prediction of the current block.

(26). The method of any of features (16) to (25), in which the applying includes: determining that the reference block crosses at least an edge of two coded blocks; and applying a deblocking filter on at least neighboring samples of the edge in the reference block.

(27). The method of any of features (16) to (26), further including: encoding the block vector into the coded video bitstream.

(28). The method of any of features (16) to (27), in which the intra prediction mode is based on a template based intra mode derivation, the one or more reconstructed samples include first one or more samples in a template of the current block, and second one or more samples in a reference portion of the template of the current block, and the method includes: applying the one or more in-loop filters on the first one or more samples in the template of the current block to generate filtered first one or more samples; applying the one or more in-loop filters on the second one or more samples in the reference portion of the template of the current block to generate filtered second one or more samples; and deriving an intra mode based on the filtered first one or more samples and the filtered second one or more samples.

(29). The method of any of features (16) to (28), in which the current block is a first current block, and the method includes: storing the one or more reconstructed samples in a buffer; discarding the one or more filtered reconstructed samples after the current block has been reconstructed; and reconstructing a second current block in the current picture based on at least one of the one or more reconstructed samples that is stored in the buffer.

(30). The method of any of features (16) to (29), further including: storing the one or more filtered reconstructed samples in a picture buffer; and in response to an application of the one or more in-loop filters to the picture buffer, skipping the application of the one or more in-loop filters on the one or more filtered reconstructed samples.

(31). A method of processing visual media data, the method including: processing a bitstream of visual media data according to a format rule, in which: the bitstream includes coded information of a current block in a current picture, the coded information of the current block indicating an intra prediction mode for the current block; and the format rule specifies that: one or more in-loop filters are applied on one or more reconstructed samples in the current picture to generate one or more filtered reconstructed samples; and the current block is reconstructed using the intra prediction mode and based on the one or more filtered reconstructed samples.

(32). An apparatus for video decoding, including processing circuitry that is configured to perform the method of any of features (1) to (15).

(33). An apparatus for video encoding, including processing circuitry that is configured to perform the method of any of features (16) to (30).

(34). A non-transitory computer-readable storage medium storing instructions which when executed by at least one processor cause the at least one processor to perform the method of any of features (1) to (31).

What is claimed is:

1. A method of video decoding, comprising:
receiving a coded video bitstream comprising coded information of a current block in a current picture, the coded information of the current block indicating an intra prediction mode for the current block;
applying one or more in-loop filters on one or more reconstructed samples in the current picture to generate one or more filtered reconstructed samples; and
reconstructing the current block using the intra prediction mode and based on the one or more filtered reconstructed samples.

2. The method of claim 1, wherein the applying comprises:
determining that a data dependency requirement associated with the one or more in-loop filters is satisfied by the one or more reconstructed samples.

3. The method of claim 1, wherein the one or more in-loop filters comprise at least one of a deblocking filter, a bilateral filter, a shape adaptive filter, a wiener filter, a sample adaptive offset (SAO) filter, and/or an adaptive loop filter (ALF).

4. The method of claim 1, wherein the intra prediction mode is a block vector based intra prediction mode, and the method comprises:
determining a block vector that points to a reference block of the current block in the current picture, the reference block comprising reference samples corresponding to the one or more reconstructed samples;
applying at least the one or more in-loop filters on the reference samples to generate filtered reference samples; and
reconstructing the current block based on the filtered reference samples.

5. The method of claim 4, wherein the applying comprises:
applying the one or more in-loop filters on the reference samples in the current picture to generate intermediate filtered reference samples; and
applying at least one of a smoothing filter and/or an interpolation filter on the intermediate filtered reference samples to generate the filtered reference samples.

6. The method of claim 4, further comprising:
determining whether to apply the one or more in-loop filters on the reference samples based on coding information of the reference samples.

7. The method of claim 1, wherein the intra prediction mode is a block vector based intra prediction mode with a template-based search, and the method comprises:
applying the one or more in-loop filters on the one or more reconstructed samples in a search area of the current picture to generate the one or more filtered reconstructed samples; and
searching in the search area based on the one or more filtered reconstructed samples to determine a block vector that points to a reference block of the current block in the current picture.

8. The method of claim 1, wherein the intra prediction mode is a block vector based intra prediction mode with a template-based search, and the method comprises:
applying the one or more in-loop filters on the one or more reconstructed samples that form a current template of the current block to generate a filtered current template of the current block; and
searching in a search area based on the filtered current template of the current block to determine a block vector that points to a reference block of the current block in the current picture.

9. The method of claim 1, wherein the intra prediction mode is a block vector based intra prediction mode with a template-based search, and the method comprises:
calculating, respective cost values of a plurality of candidate reference blocks in a search area, a cost value of a candidate reference block in the plurality of candidate reference blocks being calculated based on a first template of the candidate reference block and a second template of the current block;
determining most similar templates based on the respective cost values;
applying the one or more in-loop filters on the most similar templates to generate filtered most similar templates; and
determining a block vector that points to a reference block of the current block in the current picture based on the filtered most similar templates.

10. The method of claim 1, wherein the intra prediction mode is a block vector based intra prediction mode with a template-based search, and the method comprises:
calculating, respective cost values of a plurality of candidate reference blocks in a search area, a cost value of a candidate reference block in the plurality of candidate reference blocks being calculated based on a first template of the candidate reference block and a second template of the current block;
determining a most similar block in the plurality of candidate reference blocks based on the respective cost values; and
applying the one or more in-loop filters on the most similar block to generate a prediction of the current block.

11. The method of claim 4, wherein the applying comprises:
determining that the reference block crosses at least an edge of two coded blocks; and
applying a deblocking filter on at least neighboring samples of the edge in the reference block.

12. The method of claim 4, wherein the determining the block vector comprises:
decoding the block vector that is signaled in the coded video bitstream.

13. The method of claim 1, wherein the intra prediction mode is based on a template based intra mode derivation, the one or more reconstructed samples comprises first one or more samples in a template of the current block, and second one or more samples in a reference portion of the template of the current block, and the method comprises:
applying the one or more in-loop filters on the first one or more samples in the template of the current block to generate filtered first one or more samples;
applying the one or more in-loop filters on the second one or more samples in the reference portion of the template of the current block to generate filtered second one or more samples; and
deriving an intra mode based on the filtered first one or more samples and the filtered second one or more samples.

14. The method of claim 1, wherein the current block is a first current block, and the method comprises:
storing the one or more reconstructed samples in a buffer;
discarding the one or more filtered reconstructed samples after the current block has been reconstructed; and
reconstructing a second current block in the current picture based on at least one of the one or more reconstructed samples that is stored in the buffer.

15. The method of claim 1, further comprising:
storing the one or more filtered reconstructed samples in a picture buffer; and
in response to an application of the one or more in-loop filters to the picture buffer, skipping the application of the one or more in-loop filters on the one or more filtered reconstructed samples.

16. A method of video encoding, comprising:
determining to use an intra prediction mode for coding a current block in a current picture;
applying one or more in-loop filters on one or more reconstructed samples in the current picture to generate one or more filtered reconstructed samples; and
encoding the current block into coded information in a coded video bitstream using the intra prediction mode and based on the one or more filtered reconstructed samples.

17. The method of claim 16, wherein the applying comprises:
determining that a data dependency requirement associated with the one or more in-loop filters is satisfied by the one or more reconstructed samples.

18. The method of claim 16, wherein the one or more in-loop filters comprise at least one of a deblocking filter, a bilateral filter, a shape adaptive filter, a wiener filter, a sample adaptive offset (SAO) filter, and/or an adaptive loop filter (ALF).

19. The method of claim 16, wherein the intra prediction mode is a block vector based intra prediction mode, and the method comprises:
determining a block vector that points to a reference block of the current block in the current picture, the reference block comprising reference samples corresponding to the one or more reconstructed samples;
applying at least the one or more in-loop filters on the reference samples to generate filtered reference samples; and
reconstructing the current block based on the filtered reference samples.

20. A method of processing visual media data, the method comprising:
processing a bitstream of visual media data according to a format rule, wherein:
the bitstream includes coded information of a current block in a current picture, the coded information of the current block indicating an intra prediction mode for the current block; and
the format rule specifies that:
one or more in-loop filters are applied on one or more reconstructed samples in the current picture to generate one or more filtered reconstructed samples; and
the current block is reconstructed using the intra prediction mode and based on the one or more filtered reconstructed samples.
